(19) United States
(12) Patent Application Publication
(10) Pub. No.: US 2025/0034459 A1
(43) Pub. Date: Jan. 30, 2025

(54) FLUIDIZED CATALYTIC CRACKING REGENERATION APPARATUS AND APPLICATION THEREOF

(71) Applicants: CHINA PETROLEUM & CHEMICAL CORPORATION, Beijing (CN); SINOPEC RESEARCH INSTITUTE OF PETROLEUM PROCESSING CO., LTD., Beijing (CN)

(72) Inventors: Jianhong GONG, Beijing (CN); Xiaoli WEI, Beijing (CN); Zhigang ZHANG, Beijing (CN)

(21) Appl. No.: 18/715,427

(22) PCT Filed: Dec. 2, 2022
(86) PCT No.: PCT/CN2022/136231

§ 371 Date: May 31, 2024

(30) Foreign Application Priority Data
Dec. 3, 2021 (CN) 202111467300.7
Dec. 3, 2021 (CN) 202111467959.2

(51) Int. Cl. C10G 11/18; B01J 8/18; B01J 8/26; B01J 38/34

(52) U.S. Cl. CPC C10G 11/182; B01J 8/1827; B01J 8/1881; B01J 8/26; B01J 38/34; B01J 2208/00769; B01J 2208/00938; C10G 2300/706; C10G 2300/708

(57) ABSTRACT

Disclosed is a fluidized catalytic cracking regeneration apparatus and application thereof. The fluidized catalytic cracking regeneration apparatus comprises a coke supplemental device, a regenerator and an external catalyst circulation pipe, wherein an outlet of the coke supplemental device is in fluid communication with an inlet of the regenerator, the external catalyst circulation pipe connects a lower portion of the regenerator to the coke supplemental device for returning part of catalyst in the regenerator to the coke supplemental device, the coke supplemental device is provided with an inlet for spent catalyst, an inlet for oxygen-lean gas, and an inlet for fuel oil, and an inlet for oxygen-rich gas is disposed at bottom of the regenerator, wherein the inlet for fuel oil is disposed at a position downstream of the inlet for spent catalyst along a direction of stream flow.

### TECHNICAL FIELD

The present application relates to the technical field of fluidized catalytic cracking, in particular to fluidized catalytic cracking regeneration apparatus and application thereof.

### BACKGROUND OF ART

The fluidized catalytic cracking reaction process is a self-heat balance process. A large amount of high level energy released during the catalyst coke burning regeneration process can just meet the low level energy required in the cracking reaction. The catalyst circulating between the reactor and the regenerator has sufficient quantity and heat capacity, such that the catalyst can act both as an active site for the reaction and as a heat carrier for the transfer of heat energy. The catalyst flows between the reactor and the regenerator, continuously acquiring heat from one end and in turn supplying heat to the other end. The establishment of heat balance requires certain conditions, on the basis of which the reaction and regeneration can be ensured to reach the specified temperature. For a catalytic cracking industrial unit, the heat balance between the reactor and the regenerator is based on the fact that the reaction can produce sufficient coke, which is burned during the regeneration process to release heat to be used for the reaction.

With the development of oil refining process, especially the intensification of the heavy/inferior trend of crude oil and the improvement of the quality of oil products, the hydrogenation process has been more widely used. When the heavy oil subjected to hydrogenation upgrading are used as catalytic cracking feedstocks, although the structure and quality of the product are greatly improved, it brings about insufficient coke generation for the catalytic cracking unit itself, resulting in insufficient heat supply. In addition, in the catalytic cracking technology targeting light olefins as the main products, the cracking reaction has a high conversion rate and temperature, resulting in large heat needed. The heat required in terms of reaction is more than that of a conventional fluidized catalytic regenerator or other catalytic conversion methods, and the coke generated cannot meet the requirements of heat balance of the reaction-regeneration system. When there is insufficient coke generation during the reaction, extra fuel oil is usually supplied to the regenerator to provide the required heat for the reaction. However, since the catalytic cracking uses a catalyst with a molecular sieve serving as an active component, the local high temperature generated by the combustion of fuel oil in a regenerator gradually removes aluminum from the molecular sieve framework, resulting in irreversible damage to the catalyst. The prior art does not fundamentally solve the influence of high-temperature hot spots generated by local combustion of the extra fuel oil on the catalyst framework structure and reaction performance.

### SUMMARY OF THE INVENTION

The present application aims to provide a fluidized catalytic cracking regeneration apparatus and a method suitable for maintaining heat balance, which can solve the problem of heat balance in a catalytic cracking reaction with less coke generation and simultaneously do not influence the physical and chemical properties of the catalyst.

In order to achieve the above object, in one aspect, the present application provides a fluidized catalytic cracking regeneration apparatus, which comprises a coke supplemental device, a regenerator, and an external catalyst circulation pipe, wherein an outlet of the coke supplemental device is in fluid communication with an inlet of the regenerator, the external catalyst circulation pipe connects a lower portion of the regenerator to the coke supplemental device for returning part of catalyst in the regenerator to the coke supplemental device, the coke supplemental device is provided with an inlet for spent catalyst, an inlet for oxygen-lean gas, and an inlet for fuel oil, and an inlet for oxygen-rich gas is disposed at bottom of the regenerator, wherein the inlet for fuel oil is disposed at a position downstream of the inlet for spent catalyst along a direction of stream flow.

In another aspect, the present application provides a catalytic cracking system comprising a catalytic cracking reactor and the fluidized catalytic cracking regeneration apparatus according to the present application.

In still another aspect, there is provided a method for regenerating catalyst by using the fluidized catalytic cracking regeneration apparatus according to the present application, comprising steps of:
1) contacting spent catalyst with fuel oil and oxygen-lean gas in the coke supplemental device to undergo coke-generating reaction and partial coke-burning reaction to obtain partially coked catalyst; and
2) contacting the partially coked catalyst with oxygen-rich gas in the regenerator to undergo complete combustion reaction to obtain regenerated catalyst.

The regeneration apparatus according to the present application has a simple structure and is easy to implement. It can be implemented by adaptively modifying the regenerator of the existing industrial unit with strong applicability, and is particularly suitable for catalytic cracking units with petrochemical feedstock such as light olefins as the main target products. Not only can it fundamentally solve the problem of heat balance of the reaction-regeneration system, but it can also reduce the damage to the catalyst and the hardware caused by the traditional injection mode of fuel oil, which not only saves the cost of the catalyst, but also improves the economic benefits of the refinery. When the regeneration apparatus and the method according to the present application are used for fluidized catalytic cracking reaction with less coke generation, it can not only realize heat balance of the reaction-regeneration process, but also make the temperature rise of the catalyst during the coke-burning process in the regenerator uniform without local hot spots, resulting in no damage to the physical and chemical properties of the catalyst.

Additional features and advantages of the present application will be set forth in detail in the detailed description which follows.

### BRIEF DESCRIPTION OF THE DRAWING

The accompanying drawing, constituting a part of the present description, is intended to provide a further understanding of the present application, and should not be considered to be limiting. The present application can be interpreted with reference to the drawing in combination with the detailed description herein below. In the drawing:

FIG. 1 is a schematic diagram of a preferred embodiment of a fluidized catalytic cracking regeneration apparatus provided in the present application; and

FIG. 2 is a schematic diagram of another preferred embodiment of a fluidized catalytic cracking regeneration apparatus provided in the present application.

### DETAILED DESCRIPTION OF THE INVENTION

The following provides a detailed explanation of specific embodiments of the present application in conjunction with the accompanying drawing. It should be understood that the specific embodiments described herein are only intended to illustrate and explain the present application, and are not intended to limit the present application.

As used herein, the expression “exemplary” means “serving as an example, embodiment, or illustration”. Any embodiment described herein as “exemplary” is not necessarily to be construed as preferred or advantageous over other embodiments. While the various aspects of the embodiments are illustrated in the drawings, the drawings are not necessarily drawn to scale unless specifically indicated.

In addition, the technical features involved in different embodiments of the present application described below can be combined with each other as long as they do not conflict with each other. Any specific numerical value disclosed herein (including endpoints of ranges of numerical values) is not to be limited to the precise value of that numerical value, and is to be understood to also encompass values close to the precise value, for example, all possible values within ±5% of the precise value. Also, for the disclosed ranges of numerical values, one or more new ranges of numerical values can be obtained by any combination between the endpoint values of the range, between the endpoint values and specific point values within the range, and between each specific point values, and such new ranges of numerical values should also be considered to be specifically disclosed herein.

In the present application, the so-called “upstream” and “downstream” are based on the direction of flow of the reaction streams. For example, when the reaction stream flows from bottom to top, “upstream” refers to a position below, and “downstream” refers to a position above.

In the description of the present application, it should be noted that the terms “upper”, “lower”, “inner”, “outer”, “front”, “back”, “left”, “right”, etc. indicate orientations or positional relationships based on operational states of the present application, and are only for convenience of description and simplification of description, but do not indicate or imply that the device or element referred to must have a specific orientation, be constructed and operated in a specific orientation, and thus, should not be construed as limiting the present application.

In the description of the present application, it should be noted that the terms “mounted,” “coupled,” and “connected” are to be construed broadly unless otherwise explicitly specified or limited. The specific meanings of the above terms in the present application can be understood on a case-by-case basis to those of ordinary skill in the art.

Unless otherwise stated, the terms used herein have the same meanings as commonly understood by those skilled in the art. If a term is defined herein and its definition is different from the common understanding in the art, the definition herein shall prevail.

As described above, in a first aspect, the present application provides a fluidized catalytic cracking regeneration apparatus, comprising a coke supplemental device, a regenerator, and an external catalyst circulation pipe, wherein an outlet of the coke supplemental device is in fluid communication with an inlet of the regenerator, the external catalyst circulation pipe connects a lower portion of the regenerator to the coke supplemental device for returning part of catalyst in the regenerator to the coke supplemental device, the coke supplemental device is provided with an inlet for spent catalyst, an inlet for oxygen-lean gas, and an inlet for fuel oil, and an inlet for oxygen-rich gas is disposed at bottom of the regenerator, wherein the inlet for fuel oil is disposed at a position downstream of the inlet for spent catalyst along a direction of stream flow.

According to the present application, the regenerator can have the structure of the conventional regenerator, except that it is only necessary to dispose an opening at the bottom of the regenerator, and to connect the outlet of the coke supplemental device with the opening, namely, to bring the outlet of the coke supplemental device in fluid communication with the inlet of the regenerator, enabling the stream from the coke supplemental device to flow into the regenerator. In the fluidized catalytic cracking regeneration apparatus according to the present application, one or more, preferably 1-3, inlet for oxygen-rich gas is/are disposed on the sidewall of the regenerator for injecting oxygen-rich gas into the regenerator, which is used for regenerating the catalyst entering the regenerator. Preferably, a gas distributor (also referred to as a main air distributor in the present application) is further disposed at the bottom of the regenerator such that oxygen-rich gas injected through the inlet for oxygen-rich gas is passed into the regenerator through the gas distributor. According to the present application, the gas distributor may be a main air distributor well known to those skilled in the art. For example, the main air distributor may be a distribution plate and a distribution pipe. Preferably, the distribution pipe is an annular distribution pipe or a dendritic distribution pipe.

In some specific embodiments, the regenerator is in fluid communication with a gas-solid separation equipment, such that regeneration flue gas generated by the regenerator is introduced into an energy recovery system after being separated by the gas-solid separation equipment, for recycling via a regeneration flue gas line. In the present application, the gas-solid separation equipment may be equipment well known to those skilled in the art. For example, the gas-solid separation equipment may comprise a cyclone separator.

In some specific embodiments, the regenerator is further provided with an outlet for regenerated catalyst, which is used for sending the high-temperature regenerated catalyst after regeneration out of the regenerator for cyclic use in the reaction.

In the fluidized catalytic cracking regeneration apparatus according to the present application, spent catalyst with relatively low temperature (generally lower than 600° C.) is firstly contacted with fuel oil and oxygen-lean gas in the coke supplemental device to undergo coke-generating reaction and partial coke-burning reaction to obtain partially coked catalyst, and then the partially coked catalyst is passed into the regenerator to undergo sufficient coke-burning heat release under the action of high-temperature and oxygen-rich gas so as to supply heat required by the reaction. For the catalytic cracking reaction process with less coke generation, the regeneration apparatus according to the present application can not only solve the heat balance problem of the reaction-regeneration system, but also alleviate the coke-burning environment on the catalyst, and realize gradual temperature rise on the catalyst, thereby protecting the physical and chemical properties of the catalyst to the maximum extent. In contrast, when regenerated catalyst with a relatively high temperature (typically higher than 660° C.) is contacted with fuel oil, the combustion rate of carbon still increases rapidly even in an oxygen-lean environment, and the combustion reaction with oxygen releases heat, making it difficult to maintain the morphology of coke on the catalyst surface.

In a second aspect, there is provided a catalytic cracking system comprising a catalytic cracking reactor and a fluidized catalytic cracking regeneration apparatus according to the present application.

According to the present application, the catalytic cracking system may comprise one or more, preferably 1-3, catalytic cracking reactor. The fluidized catalytic cracking regeneration apparatus according to the present application may be connected with the one or more catalytic cracking reactor, such that spent catalyst from the one or more catalytic cracking reactor is passed into the regeneration apparatus according to the present application for regeneration, and the regenerated catalyst is recycled back to the one or more catalytic cracking reactor for reuse. In some specific embodiments, the catalytic cracking system further comprises an oil separation device, a stripping device, and optionally a reaction product separation device.

According to the present application, the catalytic cracking reactor, the oil separation device, the stripping device, the reaction product separation device, etc. may all be devices well known to those skilled in the art, and the connection between these devices may also be conducted in a manner known in the art. For example, the oil separation device may comprise a cyclone separator and an outlet quick separator. In some specific embodiments, the oil separation device comprises a settler disposed coaxially or in parallel at high and low level respectively with the catalytic cracking reactor.

In a third aspect, there is provided a method for regenerating catalyst by using the fluidized catalytic cracking regeneration apparatus according to the present application, comprising steps of:
1) contacting spent catalyst with fuel oil and oxygen-lean gas in the coke supplemental device to undergo coke-generating reaction and partial coke-burning reaction to obtain partially coked catalyst; and
2) contacting the partially coked catalyst with oxygen-rich gas in the regenerator to undergo complete combustion reaction to obtain regenerated catalyst.

According to the present application, the oxygen-lean gas may be selected from the group consisting of air, nitrogen, water vapor, mixtures thereof or mixtures thereof with oxygen. Preferably, the oxygen content of the oxygen-lean gas is 1-20 vol %, more preferably 5-10 vol %. According to the present application, the fuel oil may be selected from the group consisting of straight-run distillates, secondary-processed distillates or combinations thereof. Preferably, the secondary-processed distillate may be selected from the group consisting of catalytically cracked diesel, catalytically cracked slurry, coker gasoline, coker diesel, coker gas oil, or combinations thereof.

According to the present application, the oxygen content of the oxygen-rich gas is preferably 21-100 vol %, and more preferably 21-85 vol %. For example, the oxygen-rich gas may be air.

In a preferred embodiment, the temperature of the spent catalyst in step 1) is 480-650° C., preferably 540-600° C.

In some specific embodiments, the temperature within the regenerator is 620-800° C., preferably 650-750° C.; the gas superficial linear velocity is 0.2-1.0 m/s, preferably 0.3-0.8 m/s, and the mean residence time of the catalyst is 0.5-10 minutes, preferably 1-5 minutes.

The fluidized catalytic cracking regeneration apparatus, the catalytic cracking system and the method for regenerating catalyst according to the present application are suitable for various catalytic cracking reaction-regeneration systems with insufficient coke generation, such as the reaction for producing light olefins by catalytic cracking of petroleum hydrocarbons, oxygen-containing hydrocarbons, and particularly the reaction for producing light olefins by catalytic cracking of light hydrocarbons or light distillates.

For example, the light hydrocarbons or light distillates may be gaseous hydrocarbons, petroleum hydrocarbons with a distillation range of 25-350° C., oxygen-containing compounds, biomass or distillates of waste plastics generated oil; the gaseous hydrocarbon may be selected from the group consisting of saturated liquefied gas, unsaturated liquefied gas, C4 fractions, or combinations thereof; the petroleum hydrocarbon may be selected from the group consisting of primary-processed straight-run naphtha, straight-run kerosene, straight-run diesel, or combinations thereof; and secondary-processed topping oil, raffinate oil, C4 fractions, hydrocracked light naphtha, pentane oil, coker gasoline, Fischer-Tropsch synthesis oil, fluid catalytic cracked light gasoline, hydrogenated gasoline, hydrogenated diesel, or combinations thereof.

The fluidized catalytic cracking regeneration apparatus, the catalytic cracking system and the method for regenerating catalyst according to the present application can have various specific embodiments depending on the specific structure of the coke supplemental device used. Two particularly preferred embodiments are specifically described below.

### First Class of Preferred Embodiments

In the first class of preferred embodiments of the fluidized catalytic cracking regeneration apparatus according to the present application, the external catalyst circulation pipe connects the lower portion of the regenerator to the lower portion of the coke supplemental device, and the inlet for oxygen-lean gas, the connection port between the external catalyst circulation pipe and the coke supplemental device, the inlet for spent catalyst, and the inlet for fuel oil are sequentially disposed on the coke supplemental device along the direction of stream flow.

In the first class of preferred embodiments, the external catalyst circulation pipe enables a part of the high-temperature regenerated catalyst in the regenerator to flow into the lower portion of the coke supplemental device, which can be used for heating the spent catalyst in the coke supplemental device when the temperature of the spent catalyst from the reactor is low, thereby contributing to the effective development of coke-generating reaction of fuel oil.

In the first class of preferred embodiments, the coke supplemental device may be a fast fluidized bed. Preferably, the coke supplemental device is in the form of a hollow cylinder with a length-to-diameter ratio of 30:1 to 3:1, preferably 20:1 to 5:1.

In the first class of preferred embodiments, the inlet for spent catalyst, the connecting port of the external catalyst circulation pipe, the inlet for oxygen-lean gas and the inlet for fuel oil which are disposed on the coke supplemental device are positioned at different heights of the coke supplemental device. Preferably, the coke supplemental device is provided with the inlet for oxygen-lean gas, the connecting port of the external catalyst circulation pipe, the inlet for spent catalyst and the inlet for fuel oil in sequence from bottom to top, which are all positioned at the middle-lower portion of the coke supplemental device, namely at the position where the distance from the bottom of the coke supplemental device is not more than 50% of height of the coke supplemental device.

In the first class of preferred embodiments, one or more, preferably 1-3, inlet for oxygen-lean gas may be disposed at the lower portion of the coke supplemental device. Preferably, the inlet for oxygen-lean gas is disposed at the bottom of the coke supplemental device. Further preferably, a first gas distributor is further disposed at the bottom of the coke supplemental device, such that oxygen-lean gas injected through the inlet for oxygen-lean gas is passed into the coke supplemental device through the first gas distributor. According to the present application, the first gas distributor may be a distributor well known to those skilled in the art, such as a distribution plate and a distribution pipe. Preferably, the distribution pipe is an annular distribution pipe or a dendritic distribution pipe.

In the first class of preferred embodiments, the connection port between the external catalyst circulation pipe and the coke supplemental device is disposed at the lower portion of the coke supplemental device, preferably at a position which is 3% to 20%, preferably 5% to 10% of height of the coke supplemental device away from the bottom of the coke supplemental device.

In the first class of preferred embodiments, the coke supplemental device may be provided with one or more, for example, 1, 2, 3 or more inlet for fuel oil, and the one or more inlet for fuel oil may be each independently disposed at the inlet or the middle-lower portion of the coke supplemental device. Preferably, the one or more inlet for fuel oil is/are each independently disposed at the middle-lower portion of the coke supplemental device. Further preferably, the one or more inlet for fuel oil is/are each independently at a distance from the bottom of the coke supplemental device of 20% to 50%, preferably 25% to 40%, of height of the coke supplemental device.

In the first class of preferred embodiments, a catalyst distribution plate may be disposed at the position where the catalyst is passed into the bottom of the regenerator, for example at the outlet of the coke supplemental device. According to the present application, the catalyst distribution plate may be any of various types of distribution plates commonly used in industry, for example, one or more of a flat plate shape, an arch shape, a disc shape, a ring shape, and an umbrella shape. The catalyst distribution plate is beneficial to enabling the catalyst to uniformly contact with the oxygen-rich gas in concentration in the axial direction of the regenerator to carry out coke-burning reaction, such that the coke-burning efficiency is improved, and the occurrence of local hot spots of the catalyst bed layer is reduced.

In the first class of preferred embodiments, the coke supplemental device is disposed to mix the injected fuel oil with the catalyst under low-temperature and oxygen-lean fluidization condition to form coke, and the coked catalyst is back-mixed in the coke supplemental device with the characteristic of a fast fluidized bed, such that the coke is uniformly distributed on the catalyst and is partially combusted, thereby the gradient rise of the surface temperature of the catalyst is realized.

In the first class of preferred embodiments, the regenerator and the coke supplemental device may be disposed coaxially or in parallel at high and low level respectively.

In the first class of preferred embodiments of the method for regenerating catalyst according to the present application, step 1) of the method further comprises:
1a) mixing the spent catalyst with the regenerated catalyst from the regenerator through the external catalyst circulation pipe, and contacting with oxygen-lean gas injected through the inlet for oxygen-lean gas to heat up the spent catalyst and undergo partial coke-burning reaction; and
1b) contacting stream obtained in the step 1a) with a mixture of atomizing medium and fuel oil injected through the inlet for fuel oil to undergo coke-generating reaction and partial coke-burning reaction to obtain the partially coked catalyst.

In the first class of preferred embodiments, the logarithmic mean linear velocity of the coke supplemental device is preferably 1.2-2.2 m/s.

In the first class of preferred embodiments, the atomizing medium is preferably nitrogen, and the mass ratio of the atomizing medium to the fuel oil is preferably 1:1 to 1:100.

In the first class of preferred embodiments, the temperature at outlet of the coke supplemental device is preferably 550-650° C.

The first preferred embodiment of the present application will be further described with reference to the accompanying drawings, but the present application is not limited thereto.

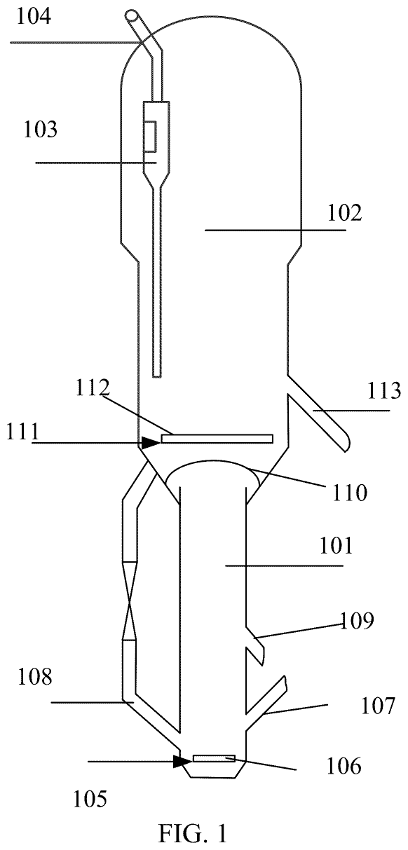

In a preferred embodiment, as shown in FIG. 1, the fluidized catalytic cracking regeneration apparatus according to the present application comprises a coke supplemental device 101 and a regenerator 102, wherein the outlet of the coke supplemental device 101 is in fluid communication with the inlet of the regenerator 102, enabling the stream from the coke supplemental device 101 to flow into the regenerator 102. The lower portion of the coke supplemental device 101 is also in communication with the lower portion of the regenerator 102 through an external catalyst circulation pipe 108, enabling a part of the high-temperature regenerated catalyst in the regenerator 102 to flow into the coke supplemental device 101 so as to heat up the spent catalyst in the coke supplemental device 101 from the reactor, thereby realizing optimized utilization of energy.

An inlet for oxygen-lean gas 105 and a first gas distributor 106 are disposed at the bottom of the coke supplemental device 101; an inlet for spent catalyst 107 and a connecting port of the external catalyst circulation pipe 108 are disposed at the sidewall of the lower portion of the coke supplemental device 101; and an inlet for fuel oil 109 is disposed at the middle-lower portion of the coke supplemental device 101. A secondary gas distributor (i.e., main air distributor) 112 is disposed at the bottom of the regenerator 102, and one or more, e.g., 1, 2, 3, or more, inlet for oxygen-rich gas (i.e., main air inlet) 111 is/are disposed at the sidewall of the bottom.

Oxygen-lean gas is passed into the coke supplemental device 101 from the bottom of the coke supplemental device 101 through the inlet for oxygen-lean gas 105. High-temperature regenerated catalyst from the external catalyst circulation pipe 108 is passed into the lower portion of the coke supplemental device 101, mixed with the oxygen-lean gas and moved upwards, contacted with spent catalyst from the inlet for spent catalyst 107 to undergo partial coke-burning reaction. The reaction stream continues to move upwards, which is contacted with fuel oil from the inlet for fuel oil 109 to undergo coke-generating reaction and partial coke-burning reaction. The coked catalyst flows upward, which is passed into the regenerator 102 through the catalyst distributor 110, contacted with oxygen-rich gas injected through the inlet for oxygen-rich gas 111 and the second gas distributor 112 to undergo complete combustion reaction, thereby releasing heat completely. The regenerated catalyst is discharged from the regenerator through an outlet for regenerated catalyst 113, for reuse in the reaction. The regeneration flue gas is passed into an energy recovery system via line 104 after entrained catalyst is separated by a cyclone separator 103.

### Second Class of Preferred Embodiments

In the second class of preferred embodiments of the fluidized catalytic cracking regeneration apparatus according to the present application, the coke supplemental device comprises a pre-lift zone, a coke-generating zone and a pre-combustion zone in sequence along the direction of stream flow, wherein the outlet of the pre-lift zone is in fluid communication with the inlet of the coke-generating zone, the outlet of the coke-generating zone is in fluid communication with the inlet of the pre-combustion zone, the outlet of the pre-combustion zone is in fluid communication with the inlet of the regenerator, and the external catalyst circulation pipe connects the lower portion of the regenerator to the lower portion of the pre-combustion zone; the inlet for spent catalyst is disposed on the sidewall of the pre-lift zone, and the inlet for fuel oil is provided with one or more, preferably 1-3, and each independently disposed on the sidewall of the pre-lift zone and/or the sidewall of the coke-generating zone, and the inlet for oxygen-lean gas is disposed on the sidewall of the pre-combustion zone.

In the second class of preferred embodiments, the external catalyst circulation pipe enables a part of the high-temperature regenerated catalyst in the regenerator to flow into the lower portion of the pre-combustion zone, which is used for heating the coked spent catalyst from the coke-generating zone. When the coke content on the spent catalyst is relatively high, it is beneficial for the combustion of coke on the spent catalyst and heat release, thereby realizing the gradient temperature rise of the spent catalyst and avoiding the tail combustion phenomenon caused by incomplete combustion due to the fact that a large amount of coke is brought into the main combustion zone.

In the second class of preferred embodiments, the fluidized catalytic cracking regeneration apparatus according to the present application comprises a pre-lift zone disposed at the lowest portion of the fluidized catalytic cracking regeneration apparatus, being upstream of the flow direction of the spent catalyst in the fluidized catalytic cracking regeneration apparatus. The lower portion of the pre-lift zone is provided with an inlet for spent catalyst, which is used for conveying the spent catalyst from the catalytic cracking reaction device to the fluidized catalytic cracking regeneration apparatus for regeneration. Pre-lift medium is input from the lower inlet of the pre-lift zone and is used for lifting the input spent catalyst upwards. The pre-lift medium used in the pre-lift zone may be nitrogen, water vapor or mixtures thereof. Preferably, the pre-lift zone may be in the form of a hollow cylinder with constant diameter, which may have a length-to-diameter ratio of 30:1 to 3:1, preferably 20:1 to 5:1.

In the second class of preferred embodiments, the fluidized catalytic cracking regeneration apparatus according to the application comprises a coke-generating zone disposed above the pre-lift zone for further rectifying coked catalyst therein to provide a uniform distribution of coke on the catalyst. In some further preferred embodiments, the coke-generating zone is a pneumatic conveying bed or a fast fluidized bed. Preferably, the coke-generating zone is in the form of a hollow cylinder with constant diameter, which may have a length-to-diameter ratio of 30:1 to 3:1, preferably 20:1 to 5:1.

In some further preferred embodiments, the ratio of inner diameter of the pre-lift zone to inner diameter of the coke-generating zone is 0.2:1 to 0.8:1, preferably 0.3:1 to 0.6:1, and the ratio of height of the pre-lift zone to height of the coke-generating zone is 0.5:1 to 1.5:1, preferably 0.8:1 to 1.2:1.

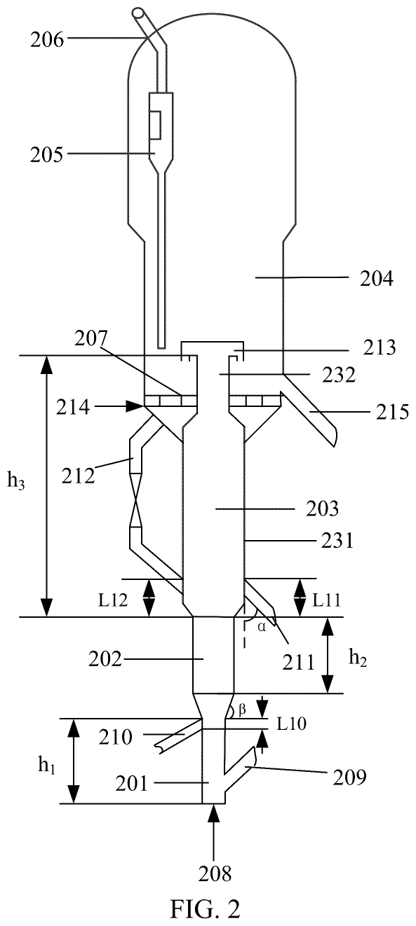

In some further preferred embodiments, the coke-generating zone and the pre-lift zone may be connected by a first connecting section therebetween. Preferably, the longitudinal section of the first connecting section is an isosceles trapezoid, and the outer inclination angle β of the side of the isosceles trapezoid is 5-85° (as shown in FIG. 2).

In the second class of preferred embodiments, one or more, preferably 1-3, inlet for fuel oil is/are disposed on the sidewall of the pre-lift zone and/or on the sidewall of the coke-generating zone, for injecting fuel oil.

In some further preferred embodiments, one or more, preferably 1-3, inlet for fuel oil is/are disposed on the sidewall of the pre-lift zone at a distance from the outlet end of the pre-lift zone that is each independently 0% to 15%; preferably 0% to 10%, of height of the pre-lift zone.

In yet further preferred embodiments, one or more, preferably 1-3, inlet for fuel oil is/are disposed on the sidewall of the coke-generating zone at a distance from the bottom of the coke-generating zone that is each independently 0% to 15%, preferably 0 to 10%, of height of the coke-generating zone.

The fuel oil is injected into the pre-lift zone and/or the coke-generating zone, such that the injected fuel oil can be mixed with the catalyst under low-temperature and oxygen-free or oxygen-lean fluidization condition to form coke, and the coked catalyst can be further rectified in the coke-generating zone, such that coke is distributed uniformly on the catalyst.

In the second class of preferred embodiments, the fluidized catalytic cracking regeneration apparatus according to the application comprises a pre-combustion zone, which is provided with one or more, preferably 1-3, inlet for oxygen-lean gas on the sidewall thereof. The pre-combustion zone is disposed for the uniformly coked catalyst entering therein and contacting with the oxygen-containing gas at a relatively low temperature and a relatively high gas linear velocity, such that the coke on the catalyst is partially combusted, and the gradient rise of the surface temperature of the catalyst is realized.

In further preferred embodiments, one or more, preferably 1-3, inlet for oxygen-lean gas is/are disposed in the lower portion of the pre-combustion zone, a gas nozzle disposed in the inlet for oxygen-lean gas is located at a distance from the bottom of the pre-combustion zone that is each independently 5% to 30%, preferably 10% to 20%, of height of the pre-combustion zone. Preferably, the gas nozzle line has an axial angle α of 5-85°, preferably 15-75°.

In further preferred embodiments, the pre-lift zone, coke-generating zone and pre-combustion zone are each in the form of a hollow cylinder and may be disposed coaxially.

In the second class of preferred embodiments, the pre-combustion zone is also in communication with the regenerator through an external catalyst circulation pipe. Preferably, the external catalyst circulation pipe is connected to the pre-combustion zone at a position with a distance from the bottom of the pre-combustion zone that is 0-20%, preferably 3-10%, of height of the pre-combustion zone. A part of the regenerated catalyst in the regenerator may be circulated back to the pre-combustion zone through the external catalyst circulation pipe and mixed with the catalyst from the coke-generating zone to raise its temperature.

In the second class of preferred embodiments, the regenerator and the pre-combustion zone can be disposed coaxially or in parallel at high and low level respectively. Preferably, the regenerator, the coke-generating zone and the pre-combustion zone are disposed coaxially.

In further preferred embodiments, the pre-combustion zone comprises a partial combustion section and an outlet section, wherein the inner diameter of the partial combustion section is larger than the inner diameter of the outlet section. Preferably, the ratio of internal diameter of the partial combustion section to internal diameter of the outlet section is 10:1 to 2:1, the ratio of height of the partial combustion section to height of the outlet section is 10:1 to 2:1.

In further preferred embodiments, a catalyst discharge pipe is disposed at the top of the outlet section of the pre-combustion zone, and the outlet section of the pre-combustion zone, together with the catalyst discharge pipe, is located inside the regenerator, such that the catalyst from the pre-combustion zone can be directly introduced into the regenerator through the catalyst discharge pipe, thereby realizing complete combustion and regeneration in the regenerator. For example, the regenerator may be configured as an existing conventional catalytic cracking single-stage regenerator, and an opening is disposed at its lower portion, such that the outlet section of the pre-combustion zone, together with the catalyst discharge pipe, is included inside the regenerator through this opening.

In the second class of preferred embodiments of the method for regenerating catalyst according to the present application, step 1) of the method further comprises:
1a′) contacting the spent catalyst introduced through the pre-lift zone with a mixture of atomizing medium and fuel oil injected through the inlet for fuel oil in the coke-generating zone to undergo coke-generating reaction to obtain coked catalyst; and
1b′) mixing and heating up stream obtained in the step 1a′) with the regenerated catalyst from the regenerator through the external catalyst circulation pipe in the pre-combustion zone, and contacting with oxygen-lean gas injected through the inlet for oxygen-lean gas to undergo partial coke-burning reaction to obtain the partially coked catalyst.

In the second class of preferred embodiments, pre-lift medium can be injected into the pre-lift zone to lift the spent catalyst, and the pre-lift medium used may be nitrogen, water vapor or mixtures thereof.

In the second class of preferred embodiments, in order to better disperse the fuel oil, the fuel oil can be mixed with the atomizing medium and the mixture thereof is injected through the inlet for fuel oil. Preferably, the atomizing medium may be nitrogen. Further preferably, the mass ratio of the fuel oil to the atomizing medium may be 1:1 to 100:1, e.g., 1:1 to 50:1, or, 1:1 to 20:1. In practical operation, the injection amount of the mixture of the atomizing medium and the fuel oil is adjusted according to the feed amount of the feed oil in the reactor connected with this regenerator, and is used for controlling the temperature of the regenerated catalyst after regeneration to be 620-800° C.

In the second class of preferred embodiments, the pre-combustion zone preferably has a logarithmic mean linear velocity of 1.2-2.2 m/s; the temperature at the outlet of the pre-combustion zone is preferably 550-650° C.

The second class of preferred embodiments of the present application will be further described with reference to the accompanying drawings, but the present application is not limited thereto. In a preferred embodiment, as shown in FIG. 2, the fluidized catalytic cracking regeneration apparatus according to the present application comprises a pre-lift zone 201, a coke-generating zone 202, a pre-combustion zone 203, and a regenerator 204 in sequence from bottom to top. An inlet for pre-lift medium 208 is disposed at the bottom of the pre-lift zone 201, an inlet for spent catalyst 209 is disposed at the lower portion, and an inlet for fuel oil 210 is disposed at the upper outlet end. One or more, preferably 1-3, inlet for oxygen-containing gas 211 is disposed at the lower sidewall of the pre-combustion zone 203. The pre-combustion zone 203 comprises a partial combustion section 231 and an outlet section 232, wherein a catalyst discharge pipe 213 is disposed at the top of the outlet section 232 of the pre-combustion zone, and the outlet section 232 of the pre-combustion zone, together with the catalyst discharge pipe 213, is located inside the regenerator. A gas distributor 207 is disposed at the bottom of the regenerator 204 and one or more, e.g. 1, 2, 3 or more, inlet for oxygen-rich gas 214 is/are disposed at the sidewall of the bottom. The lower portion of the regenerator 204 is also in communication with the lower portion of the pre-combustion zone 203 via an external catalyst circulation pipe 212.

Pre-lift medium, which may be nitrogen, water vapor or mixtures thereof, is passed into the fluidized catalytic cracking regeneration apparatus via line 208 from the bottom of the pre-lift zone 201. The spent catalyst from the inlet for spent catalyst 209 is passed into the lower portion of the pre-lift zone 201 and moves upward under the lifting action of the pre-lift medium. The fuel oil and atomizing medium are injected into the top of the pre-lift zone 201 through the inlet for fuel oil 210, mixed and contacted with the catalyst in the coke-generating zone 202 to undergo coke-generating reaction. The coked catalyst flows upward, which is passed into the pre-combustion zone 203, mixed and heated up with the high-temperature regenerated catalyst returned through the external catalyst circulation pipe 212, and contacted with oxygen-lean gas injected through the inlet for oxygen-lean gas 211 to undergo partial coke-burning reaction so as to burn off part of coke on the catalyst. The partially coked catalyst obtained is passed into the regenerator 204 through the discharge pipe 213, contacted with oxygen-rich gas injected through the inlet for oxygen-rich gas 214 and the gas distributor 207 to undergo complete combustion reaction, thereby releasing heat completely. The regenerated catalyst is discharged from the regenerator through an outlet for catalyst 215, for reuse in the reaction; the regeneration flue gas is passed into an energy recovery system via line 206 after entrained catalyst is separated by a cyclone separator 205.

In some preferred embodiments, the present application provides the following preferred embodiments:

A1. A fluidized catalytic cracking regeneration apparatus suitable for maintaining heat balance, wherein the fluidized catalytic cracking regeneration apparatus comprises a coke supplemental device and a regenerator, and an outlet of the coke supplemental device is in fluid communication with an inlet of the regenerator, enabling stream from the coke supplemental device to flow into the regenerator;
wherein the coke supplemental device is provided with an inlet for spent catalyst, an inlet for oxygen-lean gas and an inlet for fuel oil;
the regenerator is provided with an inlet for oxygen-rich gas; and
the bottom of the coke supplemental device is in communication with the bottom of the regenerator through an external catalyst circulation pipe.

A2. The fluidized catalytic cracking regeneration apparatus according to Item A1, wherein the coke supplemental device is provided with the inlet for oxygen-lean gas, a connection port of the external catalyst circulation pipe, the inlet for spent catalyst, and the inlet for fuel oil in sequence from bottom to top.

A3. The fluidized catalytic cracking regeneration apparatus according to Item A2, wherein the connection port of the external catalyst circulation pipe is disposed on the coke supplemental device at a position where a distance from the bottom of the coke supplemental device is 5% to 10% of height of the coke supplemental device.

A4. The fluidized catalytic cracking regeneration apparatus according to Item A1, wherein the inlet for fuel oil are each independently disposed mid-upstream of the coke supplemental device.

A5. The fluidized catalytic cracking regeneration apparatus according to Item A1, wherein the inlet for fuel oil are each independently disposed at a position where a distance from the bottom of the coke supplemental device is 20% to 50% of height of the coke supplemental device.

A6. The fluidized catalytic cracking regeneration apparatus according to Item A1, wherein a first gas distributor is disposed at the bottom of the coke supplemental device, such that oxygen-lean gas injected through the inlet for oxygen-lean gas is passed into the coke supplemental device through the first gas distributor.

A7. The fluidized catalytic cracking regeneration apparatus according to Item A1, wherein a catalyst distribution plate is disposed at the outlet of the coke supplemental device.

A8. The fluidized catalytic cracking regeneration apparatus according to Item A1, wherein the coke supplemental device is in a form of a hollow cylinder with a length-to-diameter ratio of 30:1 to 3:1.

A9. The fluidized catalytic cracking regeneration apparatus according to Item A1, wherein a second gas distributor is disposed at the bottom of the regenerator, such that oxygen-rich gas injected through the inlet for oxygen-rich gas is passed into the regenerator through the second gas distributor.

A10. The fluidized catalytic cracking regeneration apparatus according to Item A1, wherein the regenerator is in fluid communication with a gas-solid separation equipment, such that the regeneration flue gas generated by the regenerator is introduced into an energy recovery system after being separated by the gas-solid separation equipment.

A11. A method for regenerating a catalytic cracking catalyst, carried out in the fluidized catalytic cracking regeneration apparatus according to any of Items A1 to A10, comprising steps of: injecting oxygen-lean gas into a coke supplemental device through an inlet for oxygen-lean gas, contacting the oxygen-lean gas with the regenerated catalyst from the regenerator and spent catalyst from a reactor, so as to heat up the spent catalyst and undergo partial coke-burning reaction;
injecting a mixture of atomizing medium and fuel oil into the coke supplemental device through an inlet for fuel oil, and contacting the mixture of the atomizing medium and the fuel oil with the catalyst in the coke supplemental device to undergo coke-generating reaction and partial coke-burning reaction to obtain the partially coked catalyst; and
passing the partially coked catalyst into the regenerator, contacting the partially coked catalyst with oxygen-rich gas injected into the regenerator through an inlet for oxygen-rich gas to undergo complete combustion reaction to obtain regenerated catalyst.

A12. The regeneration method according to Item A11, wherein the coke supplemental device has a logarithmic mean linear velocity of 1.2 m/s-2.2 m/s, and the oxygen-lean gas has an oxygen content of 1% to 20%, and further preferably, the oxygen-lean gas has an oxygen content of 5% to 10%.

A13. The regeneration method according to Item A11, wherein the atomizing medium is nitrogen and the mass ratio of atomizing medium to fuel oil is 1:1 to 1:100.

A14. The regeneration method according to Item A11, wherein the coke supplemental device has an outlet temperature of 550-650° C.

A15. The regeneration method according to Item A11, wherein the oxygen-rich gas in the regenerator has an oxygen content of 21 vol % to 100 vol %, further preferably, the oxygen-rich gas has an oxygen content of 21 vol % to 85 vol %.

A16. The regeneration method according to Item A11, wherein the temperature within the regenerator is 600-800° C.

A17. A catalytic cracking system comprising the catalyst regeneration apparatus according to any one of Items A1-A10.

B1. A fluidized catalytic cracking regeneration apparatus, wherein the fluidized catalytic cracking regeneration apparatus comprises, in sequence from bottom to top: a pre-lift zone, a coke-generating zone, a pre-combustion zone and a regenerator,
wherein an outlet of the pre-lift zone is in fluid communication with an inlet of the coke-generating zone, an outlet of the coke-generating zone is in fluid communication with an inlet of the pre-combustion zone, an outlet of the pre-combustion zone is in fluid communication with an inlet of the regenerator; and the pre-combustion zone is in communication with the regenerator through an external catalyst circulation pipe;
one or more inlet for fuel oil is/are disposed on a sidewall of the pre-lift zone and/or a sidewall of the coke-generating zone;

one or more inlet for oxygen-lean gas is/are disposed on a sidewall of the pre-combustion zone; and
one or more inlet for oxygen-rich gas is/are disposed on a sidewall of the regenerator.

B2. The fluidized catalytic cracking regeneration apparatus according to Item B1, wherein one or more of the inlet for fuel oil is/are disposed on the sidewall of the pre-lift zone at a distance from the outlet end of the pre-lift zone that is each independently of 0% to 15%; preferably 0% to 10% of the height of pre-lift zone.

B3. The fluidized catalytic cracking regeneration apparatus according to Item B1, wherein the one or more of inlet for fuel oil is/are disposed on the sidewall of the coke-generating zone at a distance from the bottom of the coke-generating zone that is each independently 0% to 15%, preferably 0-10%, of height of the coke-generating zone.

B4. The fluidized catalytic cracking regeneration apparatus according to Item B1, wherein the inlet for oxygen-lean gas is disposed at a lower portion of the pre-combustion zone, and the inlet for oxygen-lean gas has a nozzle located at a distance from the bottom of the pre-combustion zone that is each independently 15% to 30% of height of the pre-combustion zone.

B5. The fluidized catalytic cracking regeneration apparatus according to Item B4, wherein the nozzle line of the inlet for oxygen-lean gas has an axial angle of 5-85°, preferably 15-75°.

B6. The fluidized catalytic cracking regeneration apparatus according to Item B1, wherein the catalyst circulation pipe is connected to the pre-combustion zone at a position with a distance from the bottom of the pre-combustion zone that is each independently 0-10% of height of the pre-combustion zone.

B7. The fluidized catalytic cracking regeneration apparatus according to Item B1, wherein the regenerator, the coke-generating zone, and the pre-combustion zone are disposed coaxially.

B8. The fluidized catalytic cracking regeneration apparatus according to Item B7, wherein a catalyst discharge pipe is disposed at the top of the outlet of the pre-combustion zone, and the outlet of the pre-combustion zone, together with the catalyst discharge pipe, is located inside the regenerator.

B9. The fluidized catalytic cracking regeneration apparatus according to Item B1, wherein a gas distributor is disposed at a lower portion of the regenerator, which is configured to distribute oxygen-rich gas input through one or more inlet for oxygen-rich gas disposed on the sidewall of the regenerator.

B10. The fluidized catalytic cracking regeneration apparatus according to Item B1, wherein the ratio of internal diameter of the pre-lift zone to internal diameter of the coke-generating zone is 0.2:1 to 0.8:1, and the ratio of height of the pre-lift zone to height of the coke-generating zone is 0.5:1 to 1.5:1.

B11. The fluidized catalytic cracking regeneration apparatus according to Item B1, wherein the pre-combustion zone comprises a partial combustion section and an outlet section, wherein the partial combustion section has an internal diameter greater than that of the outlet section.

B12. The fluidized catalytic cracking regeneration apparatus according to Item B11, wherein the ratio of internal diameter of the partial combustion section to internal diameter of the outlet section is 10:1 to 2:1, and the ratio of height of the partial combustion section to height of the outlet section is 10:1 to 2:1.

B13. A catalytic cracking regeneration method, carried out in the fluidized catalytic cracking regeneration apparatus according to any one of Items B1-B12, comprising steps of:
introducing spent catalyst into the pre-lift zone of the regenerator, contacting and mixing with pre-lift medium, and moving upwards;
mixing atomized medium and fuel oil, injecting the mixture into the fluidized catalytic cracking regeneration apparatus at one or more inlet for fuel oil, and contacting the mixture with existing stream in the fluidized catalytic cracking regeneration apparatus to undergo coke-generating reaction to obtain coked catalyst;
introducing the coked catalyst into the pre-combustion zone, mixing and heating up the coked catalyst with the regenerated catalyst circulated back to the pre-combustion zone through the catalyst circulation pipe to undergo partial combustion reaction in the presence of oxygen-lean gas introduced through one or more of the inlet for oxygen-lean gas; and
introducing partially coked catalyst into the regenerator to undergo complete combustion reaction in the presence of oxygen-rich gas introduced through one or more of the inlet for oxygen-rich gas to obtain regenerated catalyst.

B14. The regeneration process according to Item B13, wherein the pre-lift medium in the pre-lift zone is nitrogen, water vapor, or mixtures thereof; the atomizing medium is nitrogen.

B15. The regeneration method according to Item B13, wherein the mass ratio of the atomizing medium to fuel oil is 1:1 to 1:100.

B16. The regeneration method according to Item B13, wherein the pre-combustion zone has a logarithmic mean linear velocity of 1.2-2.2 m/s; the oxygen-lean gas has an oxygen content of 1-20 vol %, and further preferably, the oxygen-lean gas has an oxygen content of 5-10 vol %.

B17. The regeneration method according to Item B13, wherein the temperature within the pre-combustion zone is 550-650° C.

B18. The regeneration method according to Item B13, wherein the oxygen-rich gas in the regenerator has an oxygen content of 21 vol % to 100 vol %, and further preferably, the oxygen-rich gas has an oxygen content of 21 vol % to 85 vol %.

B19. The regeneration method according to Item B13, wherein the temperature within the regenerator is 600-800° C.

B20. A catalytic cracking system comprising the fluidized catalytic cracking regeneration apparatus according to any of Items B1-B12.

### EXAMPLES

The following examples further illustrate the present application but are not intended to limit the application thereto. The catalyst used in the tests is spent catalyst with carbon content of 0.8 wt %, and the fuel oil is LCO from commercial catalytic cracking unit.

### Example 1

The regeneration apparatus used in this example was constructed as shown in FIG. 1. A rapid bed reactor of medium-sized plant was used as the coke supplemental device and a regenerator of medium-sized plant was used as the regenerator. The coke supplemental device had an internal diameter of 0.3 m and a height of 2 m; the coke supplemental device had an inlet for fuel oil disposed at a distance from the bottom of the coke supplemental device that was 30% of height of the coke supplemental device; the outlet of the coke supplemental device was directly in communication with the bottom opening of the regenerator, and a catalyst distributor was disposed at the outlet.

A mixture of nitrogen and air with an oxygen content of 5% was introduced into the bottom of the coke supplemental device, mixed with regenerated catalyst and spent catalyst in sequence, and moved upward, so as to heat up the spent catalyst and enable carbon on the spent catalyst to undergo partial combustion reaction; the fuel oil atomized by nitrogen was injected into the coke supplemental device, and contacted with the stream in the coke supplemental device to undergo coke-generating reaction and a small amount of coke-burning reaction; the coked catalyst was passed into the regenerator and contacted with air entering the regenerator through the main air distributor to undergo complete combustion reaction, thereby releasing heat. The main operating conditions for the regeneration process and the temperature profile change of the regenerator are shown in Table 1.

A temperature measuring point was set at the outlet of the coke supplemental device to measure the temperature at outlet of the coke supplemental device; two temperature measuring points (with an angle of 180 degrees relative to the axial direction) were set at the same height that was 40% of the axial height of the regenerator from the bottom in the axial direction of the regenerator, at the positions close to the regenerator wall, to measure the temperatures in the middle portion at different positions at the same height; and a temperature measuring point was set at the top of the regenerator to measure the temperature in the upper portion of the regenerator. As can be seen from Table 1, in Example 1, the temperature at outlet of the coke supplemental device was 675° C., the temperatures at different positions in the middle portion of the regenerator were 687° C. and 681° C. respectively, with a radial temperature difference of only 6° C., and the temperature in the upper portion of the regenerator was 695° C., with a small temperature difference from the temperature in the middle portion.

### Comparative Example 1

A conventional catalytic cracking single-stage regenerator was used in this Comparative Example, which had the same structure and dimensions as those of the regenerator in Example 1, except that there was only an injection port for fuel oil disposed in the catalyst dense-phase bed layer zone at the lower portion of the regenerator.

The spent catalyst was passed into the lower portion of the regenerator and contacted with air entering the regenerator through the main air distributor to undergo coke burning reaction. The fuel oil was injected into the catalyst dense-phase bed layer, and contacted with high-temperature air to undergo coke burning reaction, thereby releasing heat. The main operating conditions for the regeneration process and the temperature profile change of the regenerator are shown in Table 1.

Two temperature measuring points (with an angle of 180 degrees relative to the axial direction) were set at the same height that was 40% of the axial height of the regenerator from the bottom in the axial direction of the regenerator, at the positions close to the regenerator wall, to measure the temperatures in the middle portion at different positions at the same height; and a temperature measuring point was set at the top of the regenerator to measure the temperature in the upper portion of the regenerator.

As can be seen from Table 1, in Comparative Example 1, the temperatures at different positions in the middle portion of the regenerator were 668° C. and 725° C. respectively, with a radial temperature difference reaching 57° C., and the temperature in the upper portion of the regenerator was 737° C., with a large temperature difference from the temperature in the middle portion.

TABLE 1
Comparison of regeneration results for
Example 1 and Comparative Example 1

| | | Comparative |
|---|---|---|
| | Example 1 | Example 1 |
| Temperature at inlet for spent catalyst | 580 | 580 |
| Temperature at outlet of coke | 675 | / |
| supplemental device | | |
| Amount of fuel oil used, kg/hr | 218 | 211 |
| Oxygen content in oxygen-lean gas, wt % | 5 | / |
| Temperature 1 in middle portion of | 687 | 725 |
| regenerator, ° C. | | |
| Temperature 2 in middle portion of | 681 | 668 |
| regenerator, ° C. | | |
| Temperature in upper portion of | 695 | 737 |
| regenerator, ° C. | | |

### Example 2

The regeneration apparatus used in this example was constructed as shown in FIG. 2, wherein the pre-lift zone had an internal diameter of 0.05 m and a length of 1 m; the coke-generating zone had an internal diameter of 0.08 m and a length of 1 m; and the pre-combustion zone had an internal diameter of 0.3 m and a length of 2 m. The distance between the inlet for fuel oil and the outlet end of the pre-lift zone was 5% of height of the pre-lift zone, and the distance between the inlet for oxygen-lean gas and the bottom of the pre-combustion zone was 20% of height of the pre-combustion zone.

Pre-lift nitrogen was passed into the bottom of the pre-lift zone, mixed with spent catalyst and moved upwards, contacted and mixed with fuel oil injected from the top of the pre-lift zone, passed into the coke-generating zone to undergo coke-generating reaction. It was rectified continuously while moving upwards such that coke was distributed uniformly. The coked catalyst was passed into the pre-combustion zone, contacted with oxygen-lean gas (a mixture of nitrogen and air with an oxygen content of 5%) injected from the sidewall of the pre-combustion zone to undergo pre-combustion reaction so as to burn off part of coke. The partially coked catalyst was passed into the regenerator and contacted with air entering the regenerator through the main air distributor to undergo complete reaction, thereby releasing heat.

Two temperature measuring points (with an angle of 180 degrees relative to the axial direction) were set at the same height that was 40% of the axial height of the regenerator from the bottom in the axial direction of the regenerator, at the positions close to the regenerator wall, to measure the temperatures in the middle portion at different positions at the same height; and a temperature measuring point was set at the top of the regenerator to measure the temperature in the upper portion of the regenerator. The main operating conditions for the regeneration process and the temperature profile change of the regenerator are shown in Table 2.

As can be seen from Table 2, in the regenerator of Example 2, the temperatures in the middle portion at different positions at the same height radially were 683° C. and 687° C. respectively, with a radial temperature difference of only 4° C., and the temperature in the upper portion of the regenerator was 701° C., with a small temperature difference from the temperature in the middle portion.

### Comparative Example 2

A conventional catalytic cracking single-stage regenerator was used in this Comparative Example, which had the same structure and dimensions as those of the regenerator in Example 2, except that there was only an injection port for fuel oil disposed in the catalyst dense-phase bed layer zone at the lower portion of the regenerator.

The spent catalyst was passed into the lower portion of the regenerator and contacted with air entering the regenerator through the main air distributor to undergo coke burning reaction. The fuel oil was injected into the catalyst dense-phase bed layer, and contacted with high-temperature air to undergo coke burning reaction, thereby releasing heat.

Similarly, two temperature measuring points (with an angle of 180 degrees relative to the axial direction) were set at the same height that was 40% of the axial height of the regenerator from the bottom in the axial direction of the regenerator, at the positions close to the regenerator wall, to measure the temperatures in the middle portion at different positions at the same height; and a temperature measuring point was set at the top of the regenerator to measure the temperature in the upper portion of the regenerator. The main operating conditions for the regeneration process and the temperature profile change of the regenerator are shown in Table 2.

As can be seen from Table 2, in the regenerator of this Comparative Example, the temperatures in the middle portion at different positions at the same height radially were 671° C. and 730° C. respectively, with a radial temperature difference reaching 59° C., and the temperature in the upper portion of the regenerator was 740° C., with a large temperature difference from the temperature in the middle portion.

TABLE 2
Comparison of regeneration results for
Example 2 and Comparative Example 2

| | | Comparative |
|---|---|---|
| | Example 2 | Example 2 |
| Temperature of spent catalyst, ° C. | 580 | / |
| Temperature of coke-generating zone, ° C. | 570 | / |
| Amount of fuel oil used, g | 216 | 216 |
| Temperature of pre-combustion zone, ° C. | 635 | / |
| Oxygen content in oxygen-lean gas, wt % | 5 | / |
| Temperature 1 in middle portion of | 683 | 730 |
| regenerator, ° C. | | |
| Temperature 2 in middle portion of | 687 | 671 |
| regenerator, ° C. | | |
| Temperature in upper portion of | 701 | 740 |
| regenerator, ° C. | | |

From the results of the above Examples and Comparative Examples, it can be seen that the catalyst regeneration carried out by using the regeneration apparatus and method according to the present application can enable the regeneration temperature to reach the temperature required for realizing heat balance, while enabling the coke combustion environment in the regeneration apparatus to be mild and stable, with small radial and axial catalyst temperature gradients, which is beneficial for maintaining the physical and chemical properties of the catalyst. The present application has been described above in connection with preferred embodiments, which are merely exemplary and illustrative. On this basis, the present application can be subjected to various substitutions and modifications, which all fall within the protection scope of the present application.

1. A fluidized catalytic cracking regeneration apparatus, comprising a coke supplemental device, a regenerator, and an external catalyst circulation pipe, wherein an outlet of the coke supplemental device is in fluid communication with an inlet of the regenerator, the external catalyst circulation pipe connects a lower portion of the regenerator to the coke supplemental device for returning part of catalyst in the regenerator to the coke supplemental device, the coke supplemental device is provided with an inlet for spent catalyst, an inlet for oxygen-lean gas, and an inlet for fuel oil, and an inlet for oxygen-rich gas is disposed at bottom of the regenerator, wherein the inlet for fuel oil is disposed at a position downstream of the inlet for spent catalyst along a direction of stream flow.

2. The fluidized catalytic cracking regeneration apparatus according to claim 1, wherein the external catalyst circulation pipe connects the lower portion of the regenerator to a lower portion of the coke supplemental device, and the inlet for oxygen-lean gas, a connection port between the external catalyst circulation pipe and the coke supplemental device, the inlet for spent catalyst and the inlet for fuel oil are sequentially disposed on the coke supplemental device along the direction of stream flow.

3. The fluidized catalytic cracking regeneration apparatus according to claim 2, wherein the connection port of the external catalyst circulation pipe is disposed on the coke supplemental device at a distance from its bottom of 3% to 20%, preferably 5% to 10%, of height of the coke supplemental device.

4. The fluidized catalytic cracking regeneration apparatus according to claim 1, wherein the inlet for fuel oil is provided with one or more, preferably 1-3, and each independently disposed on the coke supplemental device at a distance from its bottom of 20% to 50%, preferably 25% to 40%, of height of the coke supplemental device.

5. The fluidized catalytic cracking regeneration apparatus according to claim 1, having one or more of the following features:
the inlet for oxygen-lean gas is disposed at bottom of the coke supplemental device, and a first gas distributor is also disposed at the bottom of the coke supplemental device, such that oxygen-lean gas injected through the inlet for oxygen-lean gas is passed into the coke supplemental device through the first gas distributor;
a catalyst distribution plate is disposed at the outlet of the coke supplemental device;
the coke supplemental device is in a form of hollow cylinder with a length-to-diameter ratio of 30:1 to 3:1, preferably 20:1 to 5:1;
a second gas distributor is also disposed at the bottom of the regenerator, such that oxygen-rich gas injected through the inlet for oxygen-rich gas is passed into the regenerator through the second gas distributor; and
the regenerator is in fluid communication with a gas-solid separation equipment, such that regeneration flue gas generated by the regenerator is introduced into an energy recovery system after being separated by the gas-solid separation equipment.

6. The fluidized catalytic cracking regeneration apparatus according to claim 1, wherein the coke supplemental device comprises, in sequence along the direction of stream flow, a pre-lift zone, a coke-generating zone, and a pre-combustion zone, an outlet of the pre-lift zone is in fluid communication with an inlet of the coke-generating zone, an outlet of the coke-generating zone is in fluid communication with an inlet of the pre-combustion zone, and an outlet of the pre-combustion zone is in fluid communication with the inlet of the regenerator, and the external catalyst circulation pipe connects the lower portion of the regenerator to a lower portion of the pre-combustion zone;
the inlet for spent catalyst is disposed on a sidewall of the pre-lift zone, the inlet for fuel oil is provided with one or more, preferably 1-3, and each independently disposed on the sidewall of the pre-lift zone and/or a sidewall of the coke-generating zone, and the inlet for oxygen-lean gas is disposed on a sidewall of the pre-combustion zone.

7. The fluidized catalytic cracking regeneration apparatus according to claim 6, wherein the one or more inlet for fuel oil are each independently disposed on the sidewall of the pre-lift zone at a distance from its outlet end of 0-15%, preferably 0-10%, of height of the pre-lift zone; or alternatively
the one or more inlet for fuel oil are each independently disposed on the sidewall of the coke-generating zone at a distance from its bottom of 0-15%, preferably 0-10%, of height of the coke-generating zone.

8. The fluidized catalytic cracking regeneration apparatus according to claim 6, wherein the inlet for oxygen-lean gas is disposed on a sidewall of a lower portion of the pre-combustion zone such that a gas nozzle disposed at the inlet for oxygen-lean gas is located at a distance from bottom of the pre-combustion zone of 5% to 30%, preferably 10% to 20%, of height of the pre-combustion zone;
preferably, the gas nozzle has an axial angle of 5-85°, preferably 15-75°.

9. The fluidized catalytic cracking regeneration apparatus of according to claim 6, wherein a connection port between the external catalyst circulation pipe and the sidewall of the pre-combustion zone is disposed at a distance from the bottom of the pre-combustion zone of 0-20%, preferably 0-10%, of height of the pre-combustion zone.

10. The fluidized catalytic cracking regeneration apparatus according to claim 6, having one or more of the following features:
the regenerator is disposed coaxially with the pre-lift zone, the coke-generating zone and the pre-combustion zone of the coke supplemental device;
a gas distributor is also disposed at the bottom of the regenerator, such that oxygen-rich gas injected through the inlet for oxygen-rich gas is passed into the regenerator through the gas distributor;
the ratio of inner diameter of the pre-lift zone to inner diameter of the coke-generating zone is 0.2:1 to 0.8:1, preferably 0.3:1 to 0.6:1; the ratio of height of the pre-lift zone to height of the coke-generating zone is 0.5:1 to 1.5:1, preferably 0.8:1 to 1.2:1;
the pre-combustion zone comprises, in sequence along the direction of stream flow, a partial combustion section and an outlet section, inner diameter of the partial combustion section is larger than inner diameter of the outlet section, preferably the ratio of inner diameter of the partial combustion section to inner diameter of the outlet section is 10:1 to 2:1, the ratio of height of the partial combustion section to height of the outlet section is 10:1 to 2:1; and
a catalyst discharge pipe is disposed at the top of the outlet section of the pre-combustion zone, and the outlet section of the pre-combustion zone, together with the catalyst discharge pipe, is located inside the regenerator.

11. A catalytic cracking system comprising a catalytic cracking reactor and the fluidized catalytic cracking regeneration apparatus according to claim 1.

12. A method for regenerating catalyst by using the fluidized catalytic cracking regeneration apparatus according to claim 1, comprising steps of:
1) contacting spent catalyst with fuel oil and oxygen-lean gas in the coke supplemental device to undergo coke-generating reaction and partial coke-burning reaction to obtain partially coked catalyst; and
2) contacting the partially coked catalyst with oxygen-rich gas in the regenerator to undergo complete combustion reaction to obtain regenerated catalyst,
preferably, the oxygen-lean gas has an oxygen content of 1-20 vol %, more preferably 5-10 vol %, and the oxygen-rich gas has an oxygen content of 21-100 vol %, more preferably 21-85 vol %.

13. The regeneration method according to claim 12, carried out in the fluidized catalytic cracking regeneration apparatus, wherein the external catalyst circulation pipe connects the lower portion of the regenerator to a lower portion of the coke supplemental device, and the inlet for oxygen-lean gas, a connection port between the external catalyst circulation pipe and the coke supplemental device, the inlet for spent catalyst and the inlet for fuel oil are sequentially disposed on the coke supplemental device along the direction of stream flow,
wherein the step 1) further comprises:
1a) mixing the spent catalyst with the regenerated catalyst from the regenerator through the external catalyst circulation pipe, and contacting with oxygen-lean gas injected through the inlet for oxygen-lean gas to heat up the spent catalyst and undergo partial coke-burning reaction; and
1b) contacting stream obtained in the step 1a) with a mixture of atomizing medium and fuel oil injected through the inlet for fuel oil to undergo coke-generating reaction and partial coke-burning reaction to obtain the partially coked catalyst.

14. The regeneration method according to claim 13, having one or more of the following features:
the coke supplemental device has a logarithmic mean linear velocity of 1.2-2.2 m/s;
the atomizing medium is nitrogen, and the mass ratio of the atomizing medium to the fuel oil is 1:1 to 1:100;
the temperature at outlet of the coke supplemental device is 550-650° C.; and
the temperature in the regenerator is 620-800° C.

15. The regeneration method according to claim 13, carried out in the fluidized catalytic cracking regeneration apparatus, wherein the coke supplemental device comprises, in sequence along the direction of stream flow, a pre-lift zone, a coke-generating zone, and a pre-combustion zone, an outlet of the pre-lift zone is in fluid communication with an inlet of the coke-generating zone, an outlet of the coke-generating zone is in fluid communication with an inlet of the pre-combustion zone, and an outlet of the pre-combustion zone is in fluid communication with the inlet of the regenerator, and the external catalyst circulation pipe connects the lower portion of the regenerator to a lower portion of the pre-combustion zone,
wherein the step 1) further comprises:
1a′) contacting the spent catalyst introduced through the pre-lift zone with a mixture of atomizing medium and fuel oil injected through the inlet for fuel oil in the coke-generating zone to undergo coke-generating reaction to obtain coked catalyst; and
1b′) mixing and heating up stream obtained in the step 1a′) with the regenerated catalyst from the regenerator through the external catalyst circulation pipe in the pre-combustion zone, and contacting with oxygen-lean gas injected through the inlet for oxygen-lean gas to undergo partial coke-burning reaction to obtain the partially coked catalyst.

16. The regeneration method according to claim 15, having one or more of the following features:
pre-lift medium of the pre-lift zone is nitrogen, water vapor or mixtures thereof;
the atomizing medium is nitrogen, and the mass ratio of the atomizing medium to the fuel oil is 1:1 to 1:100;
the pre-combustion zone has a logarithmic mean linear velocity of 1.2-2.2 m/s;
the temperature at outlet of the pre-combustion zone is 550-650° C.; and
the temperature in the regenerator is 620-800° C.
